(19) United States
(12) Patent Application Publication
(10) Pub. No.: US 2026/0337414 A1
(43) Pub. Date: Oct. 29, 2026

(54) FRUIT BASED LEATHER-LIKE MATERIAL AND A PROCESS FOR THE PREPARATION THEREOF

(71) Applicants: COUNCIL OF SCIENTIFIC & INDUSTRIAL RESEARCH, New Delhi (IN); AAMATI GREEN PRIVATE LIMITED, Mumbai (IN)

(72) Inventors: Palanisamy THANIKAIVELAN, Chennai (IN); Ponesakki GANESAN, Chennai (IN); Tamilselvan SHWETHA, Chennai (IN); Bindia SAHU, Chennai (IN); Vaidyanathan Ganesan VAIDYANATHAN, Chennai (IN); Pramod Kumar MITTAL, Chennai (IN); Kalarical Janardhanan SREERAM, Chennai (IN)

(73) Assignees: COUNCIL OF SCIENTIFIC & INDUSTRIAL RESEARCH, New Delhi (IN); AAMATI GREEN PRIVATE LIMITED, Mumbai (IN)

(21) Appl. No.: 19/155,410

(22) PCT Filed: Feb. 13, 2024
(86) PCT No.: PCT/IN2024/050140

§ 371 Date: Aug. 11, 2025

(30) Foreign Application Priority Data
Feb. 15, 2023 (IN) 202311010288

(51) Int. Cl. C08L 99/00; B32B 23/10; C08K 5/00; C08K 11/00

(52) U.S. Cl. CPC C08L 99/00; B32B 23/10; C08K 5/0016; C08K 11/00; B32B 2250/02; B32B 2307/7376; C08L 2205/06; C08L 2205/16; C08L 2312/00

(57) ABSTRACT

The present invention relates to a fruit based leather-like material for application in fancy lifestyle and other consumer product industries. The material may contain up to 90% of fruit fiber. A process for the preparation of the material with different size/thickness ranges is also provided. It essentially involves pulping of the fibrous matter present in waste spoiled fruit, mixing the fruit pulp with polymer as well as other additives, followed by casting and drying. The process is based on near zero discharge concept excluding the seed, into the environment. The final material, is flexible and exhibits good mechanical properties, being adequate for small consumer products. The unique feature of the technology is that it leads to a value added non-hazardous, eco-friendly product that finds potential multiple industrial applications in textiles, leather, packaging and other life style product industries. The implementation of the process is possible with minimum investment.

### FIELD OF THE INVENTION

The present invention relates to fruit based leather-like material. More particularly, the present invention provides a leather-like material based essentially on fruit fibre as an alternative to animal leather useful for making lifestyle accessories. Further, the present invention provides a process to prepare leather-like material using fruit wastes. The invention is anticipated to have significant application in food/chemical industries to utilize fruit wastes to manufacture value added non-hazardous, eco-friendly leather-like sheet material. The process provides value addition to the waste fruits from the agricultural and food industries to produce vegan leather-like material which finds potential multiple industrial applications in textiles, leather, packaging and other life style product industries. The invention shall help attain the 11^{th} and 12^{th} sustainable development goals of Sustainable Cities and Communities and Responsible Consumption and Production respectively.

### BACKGROUND OF THE INVENTION

The new generation of the current world population are looking forward to considerably reduce carbon emissions and influence the development of technologies for the near future. With the rising demand for leather and leather goods in the marketplace, environmental constraints in leather processing activity and the cost associated with high quality leather coupled with the global shift in awareness toward reducing carbon emissions, a number of materials have been made recently specifically from plant sources to resemble leathers for different applications. Although synthetic leathers are meeting the current demand, their waste disposal becomes a major environmental concern due to the recalcitrant nature of PVC/other polymers in resisting biodegradation. To overcome the issues mentioned, eco-friendly leather-like materials are being developed from various renewable bio-based resources.

India is the second largest producer of fruits in the world. India is the largest producer of bananas contributing to more than a quarter of global production. Likewise, the global production of mangoes is primarily in Asia, and India is the largest producer contributing around 50% of the total world production of mango, while the contribution to global apple production is around 3% (FAOSTAT of United Nations, 2020 & 2022). On the other hand, there is a huge volume of fruit produced is wasted and the post-harvest losses have been estimated in the range of 25-30%, which contain a high content of bio-based resources of paramount industrial importance such as cellulose, hemicellulose, and natural fibers, as reported by Kumar et al., (Molecules, 25, 2812, 2020); Acevedo et al., (Molecules, 26, 5282, 2021); and Otoni et al., (Advanced Materials, 33, 2102520, 2021). The effective utilization of these low-cost wastes for producing value-added products is a novel step in its sustainable utilization. These large quantities of waste create an opportunity in developing alternative approaches for the sustainable production of leather-like materials. Over the past decade, the global demand for vegan leather has witnessed noteworthy growth, and a greater number of consumers are inclined toward purchasing those products that are animal-free. Thus, the present invention utilized fruit wastes which are rich in fibrous matters to develop a simple process to prepare leather-like materials.

Many attempts have been paid to develop leather-like materials that are alternatives to animal leather. They are predominantly synthetic materials of different chemicals combination. These include polyurethane or polyvinyl alcohol as a primary material with the addition of solvents, acrylic resin, plasticizer, foaming stabilization agent, foam control agent, and blowing agent (CN100485119C, 2006; U.S. Pat. No. 7,306,825B2, 2003). Recently, the development of leather-like materials from natural resources/by-products led to sustainable products with reduced environmental impact.

There are few leather-like materials or leather imitations, as detailed below, that have been developed using natural products in the prior art. A plant-based leather material, “Hemp Bio Leather” was developed from hemp waste fiber residues (https://www.hempbioleather.com; KR900005574B1, 1990; U.S. Pat. No. 5,000,822A, 1991). However, this imitation leather was prepared through a multistep process which required treatment with alkali, ammonia, methylol urea, ammonium phosphate, or sodium chromate and sulfuric acid, cyclohexylcarboxyl diphenylamino thiazolyl sulfonamide. Wright (U.S. Pat. No. 902,359A, 1908) invented an imitation leather product termed “cactus leather” by treating different cut sections of cactus with tannic acid, glycerin, and water. In this process, the cactus sections were left in the tanning solution for around twelve hours.

Recently, a method for the preparation of leather analogs from fungal mycelia was disclosed (KR20220024666A, 2022). In this invention, the inactivated fungal biomass was subjected to the solution comprising a solvent and a component selected from the group consisting of polymers, crosslinking agents, and combinations and mixtures.

Although the literature on fruit leather-like materials are limited, a number of methods have been reported for the preparation of fruit leathers from a variety of fruits in the technical field of food processing, which are not relevant to the current lifestyle product applications. Tong (U.S. Pat. No. 6,624,217, 2003) developed a polymeric non-biodegradable composite material using plant fibers such as rice husk including residue of orange juice and mixtures thereof based on extrusion technology. Nevertheless, the composite is either non flexible or contain eco-sensitive chemicals and suited for disposable tableware and products applications. Kin and Chunli (WO2022/089555, 2022; CN114438795, 2022) disclosed a process to prepare fruit extract leathers to replace polyester part of the synthetic leathers. Nevertheless, the process involves spinning the fruit extract with polymer to obtain fiber and further spun into fabric to replace the polyester fabric of synthetic leathers. Volcan (US20090301347, 2009) revealed a process to prepare imitation leather from apple residues using lamination device and pressing at pressure 80-150 bar.

As can be observed from the hitherto reported prior art, all the sheet/composite materials developed so far are either non flexible or contain eco-sensitive chemicals or are based on spinning technology or lamination device to prepare textile fabrics. They are not suitable for making vegan leather-like material for lifestyle product applications. Further, waste disposal of synthetic leathers becomes a major environmental concern due to resistance to biodegradation.

Therefore, keeping in view the drawbacks of the hitherto reported prior art, the inventors of the present invention realized that there exists a dire need to provide eco-friendly leather-like vegan material, which utilizes the fruit waste such as waste of mango, banana, apple and orange with or without skin either individually or in combination, as paste or powder along with alkali, acid, polymer, plasticizer, essential oil, cross-linker, fungicide, wherein the developed fruit-based leather substitute or leather-like material from fruit waste does not cause any environmental damage.

### OBJECTIVES OF THE INVENTION

The main objective of the present invention is to provide a fruit based leather-like material, which obviates the limitations stated above.

Another objective of the invention is to provide an eco-friendly leather-like material i.e., vegan leather using whole fruit wastes with a simple process, for application in lifestyle accessories.

Still another objective of the present invention is to provide an economical process free from the use of expensive equipment.

Yet another objective of the present invention is to provide a simple process based on near zero discharge concept that does not leave any solid waste behind excluding the seed and generates negligible liquid waste.

Still yet another objective of the present invention is to prepare leather-like material with suitable quality for the making of lifestyle accessories and related applications.

### SUMMARY OF THE INVENTION

The present invention provides leather-like materials from fruit waste of mango, banana, apple and orange, and its object is to produce a leather-like substance by treating the whole fruit (excluding the seed in the case of mango) with or without skin either individually or mixture of fruits, as paste or powder of the said sections when treated and dried will have a close resemblance to leather with the thickness in the range of 0.5 mm to 2.0 mm, the said material having not less than 30 to 83 wt % of fruit fiber with tensile strength in the range of 0.5 to 12 MPa and elongation at break in the range of 10 to 120%.

In an embodiment, the present invention provides a fruit based leather-like material, characterized by fruit fiber based polymeric composite matrix in the form of a sheet having not less than 30 to 83 wt % of fruit fiber, the said sheet exhibiting thickness in the range of 0.5 mm to 2.0 mm, tensile strength in the range of 0.5 to 12 MPa and elongation at break in the range of 10 to 120%.

In an embodiment, the present invention provides fruit based leather-like material, comprising:
[a] 30 to 83 wt % of fruit paste/powder;
[b] 8 to 59 wt % of polymer(s);
[c] 0.07 to 8.3 wt % of alkali(s);
[d] 0.08 to 2.1 wt % of additive(s); optionally along with
[e] 0.2 to 11.5 wt % of other ingredients selected from plasticizer, fragrant oil, cross-linker and fungicide;
characterized by fruit fiber based polymeric composite matrix in the form of a sheet having not less than 30 to 83 wt % of fruit fiber, the said sheet exhibiting thickness in the range of 0.5 mm to 2.0 mm, tensile strength in the range of 0.5 to 12 MPa and elongation at break in the range of 10 to 120%.
wherein wt % of the components [a]-[e] in the leather-like material is 100%.

In another embodiment, the present invention provides a process for preparing the fruit based leather-like material, wherein the steps comprising:
(i) converting fruit material into a paste, optionally followed by drying at 30 to 60 degree c as well as powdering to obtain fruit paste/powder;
(ii) treating the fruit paste/powder as obtained in step (i) with 0.1 to 20% w/w of alkali under stirring condition, and 10 to 200% w/w of polymer, based on the moisture-free weight of the fruit material, at a temperature ranging from 30 to 90 degree c for a period of 10 to 30 min, followed by adding 0.1 to 5.0% w/w of an additive under constant stirring to obtain a mixture;
(iii) treating the mixture as obtained in step (ii) optionally with 1 to 10% w/w of a plasticizer and 0.1 to 10% w/w of a fragrant oil for 20 to 40 min;
(iv) treating the mixture, as obtained in step (ii) or (iii) optionally with 0.1 to 20% w/w of cross-linker for 30 to 60 min followed by 0.01 to 0.5% v/w of fungicide for 10 to 30 min, to obtain a fruit based polymeric substrate;
(v) subjecting the substrate, as obtained in step (iv) to casting, followed by drying at 40 to 70 degree c for 18 to 48 h and subsequent acid washing at a pH in the range of 3 to 5 followed by aqueous washing and drying at 40 to 70 degree c for 1 to 4 h, to obtain fruit based dry composite sheet;
(vi) affixing a natural fiber substrate on one surface of the dry composite sheet, as obtained in step (v), as an optional step, followed by surface finishing on the other side by known method to obtain fruit based leather-like material.

In still another embodiment, the present invention provides a process wherein the fruit material used is selected from mango, banana, apple, orange, either individually or in any combination.

In yet another embodiment, the present invention provides a process wherein the alkali used is selected from sodium hydroxide, potassium hydroxide, either individually or in any combination.

In still another embodiment, the present invention provides a process wherein the polymer used is selected from poly vinyl alcohol, polyurethane, biopolyurethane, polyacrylic emulsion, starch, sodium alginate, polycaprolactone and poly lactic acid, either individually or in any combination.

In yet another embodiment, the present invention provides a process wherein the additive used is selected from calcium chloride, calcium sulphate and silica gel, either individually or in any combination.

In still another embodiment, the present invention provides a process wherein the plasticizer used is selected from glycerol, ethylene glycol, sorbitol, either individually or in any combination.

In yet another embodiment, the present invention provides a process wherein the fragrant oil used is selected from lemongrass oil, lavender oil, thyme oil, jasmine oil, rose oil, either individually or in any combination.

In still another embodiment, the present invention provides a process wherein the cross-linker used is selected from glutaraldehyde, cinnamaldehyde, glyoxal, either individually or in any combination.

In yet another embodiment, the present invention provides a process wherein the natural fiber substrate used is selected from cotton fabric, cotton-jute fabric.

### DETAILS OF BIOLOGICAL RESOURCES USED IN THE INVENTION

TABLE 1

| | | | | | | Source of Access |
|---|---|---|---|---|---|---|
| | | | | | | (Name and |
| S. | Resource | Common | Scientific | Nature of | Part | Address from |
| No. | accessed | Name | Name | Resource | used | where procured) |
| 1. | Biological | Mango | Mangifera | Plant | Fruit | Wild 13°00′31.7″N |
| | Resource | | indica | | | 80°14′34.5″E |
| | | | | | | (13.008802, |
| | | | | | | 80.242908) |
| 2. | Biological | Apple | Malus | Plant | Fruit | Kovai Pazhamudir |
| | Resource | | domestica | | | Nilayam, 1, 100 |
| | | | | | | Feet Rd, |
| | | | | | | Rajalakshmi Nagar, |
| | | | | | | Velachery, |
| | | | | | | Chennai, Tamil |
| | | | | | | Nadu 600042 |
| 3. | Biological | Banana | Musa | Plant | Fruit | Kovai Pazhamudir |
| | Resource | | acuminata | | | Nilayam, 1, 100 |
| | | | | | | Feet Rd, |
| | | | | | | Rajalakshmi Nagar, |
| | | | | | | Velachery, |
| | | | | | | Chennai, Tamil |
| | | | | | | Nadu 600042 |
| 4. | Biological | Orange | Citrus | Plant | Fruit | Kovai Pazhamudir |
| | Resource | | reticulata | | | Nilayam, 1, 100 |
| | | | | | | Feet Rd, |
| | | | | | | Rajalakshmi Nagar, |
| | | | | | | Velachery, |
| | | | | | | Chennai, Tamil |
| | | | | | | Nadu 600042 |
| 5. | Biological | Lemongrass | Cymbopogon | Plant | Oil from | Jazira Agencies, 25, |
| | Resource | oil | flexuosus | | grass | Harris Road, Mount |
| | | | | | | Road, Chennai |
| | | | | | | 600002, Tamil |
| | | | | | | Nadu |
| 6. | Biological | Lavender | Lavandula | Plant | Oil from | Jazira Agencies, 25, |
| | Resource | oil | angustifolia | | flower | Harris Road, Mount |
| | | | | | | Road, Chennai |
| | | | | | | 600002, Tamil |
| | | | | | | Nadu |
| 7. | Biological | Thyme oil | Thymus | Plant | Oil from | Jazira Agencies, 25, |
| | Resource | | vulgaris | | flower | Harris Road, Mount |
| | | | | | | Road, Chennai |
| | | | | | | 600002, Tamil |
| | | | | | | Nadu |
| 8. | Biological | Jasmine | Jasminum | Plant | Oil from | Jazira Agencies, 25, |
| | Resource | oil | grandiflorum | | flower | Harris Road, Mount |
| | | | | | | Road, Chennai |
| | | | | | | 600002, Tamil |
| | | | | | | Nadu |
| 9. | Biological | Rose oil | Rosa indica | Plant | Oil from | Jazira Agencies, 25, |
| | Resource | | | | flower | Harris Road, Mount |
| | | | | | | Road, Chennai |
| | | | | | | 600002, Tamil |
| | | | | | | Nadu |
| 10. | Biological | Cotton | Gossypium | Plant | Fruit | Jazira Agencies, 25, |
| | Resource | fabric | herbaceum | | | Harris Road, Mount |
| | | | | | | Road, Chennai |
| | | | | | | 600002, Tamil |
| | | | | | | Nadu |
| 11. | Biological | Cotton-jute | Cotton-jute | Plant | Cotton- | Jazira Agencies, 25, |
| | Resource | combination | combination | | jute | Harris Road, Mount |
| | | fabric | fabric | | combination | Road, Chennai |
| | | | | | fabric | 600002, Tamil |
| | | | | | | Nadu |

### DETAILED DESCRIPTION OF THE INVENTION

Whole fruit is cut into pieces and made into a paste, optionally followed by drying at 30 to 60 °C as well as powdering, to obtain fruit paste/powder. The obtained fruit paste or powder is pretreated using 0.1 to 20% w/w of alkali with stirring. Then polymer of 10 to 200% w/w, based on the moisture-free weight of the fruit material, is added to the obtained mixture and stirred at 30 to 90 °C for about 10 to 30 min and then 0.1 to 5% w/w of additive is added under continuous stirring to obtain a mixture. To this mixture, 1 to 10% w/w of plasticizer and 0.1 to 10% w/w of fragrant oil are optionally added and stirred for 20 to 40 min. Then, 0.1 to 20% w/w of cross-linker is optionally added and stirred for 30 to 60 min followed by addition of 0.01 to 0.5% v/w of fungicide under constant stirring for 10 to 30 min, to obtain a fruit based polymeric substrate. The substrate is subjected to casting and then dried at 40 to 70 °C for 18 to 48 h. The resulting dried sheet is acid washed at a pH in the range of 3 to 5 followed by aqueous washing and subsequent drying at 40 to 70 °C for 1 to 4 h to obtain fruit based dry composite sheet. A natural fiber substrate is optionally stuck on one side of the dried composite material. The other side of the dried sheet material is surface finished by known method to obtain fruit based leather-like material.

The fruit based leather-like material exhibits the following characteristics:
Fruit fiber content: 30 to 83 wt %
Average tensile strength value: 0.5 to 12 MPa
Average elongation at break value: 10 to 120%
Average thickness of the material: 0.5 to 2.0 mm

### EXAMPLES

The following examples are given by way of illustration only and therefore should not be construed to limit the scope of the present invention in any manner.

### Example 1

225 g of mango fruit along with 25 g of banana fruit (total moisture free weight of fruit mixture was 50 g) were cut into pieces and ground to make them paste. The obtained blend of fruit paste was treated with 5 g [10 wt. %] of sodium hydroxide for 10 min. To this mixture, 29.4 ml of polyurethane (5 g [10 wt. %]; 17% of solid content) was added and stirred at 30 °C for 30 min. To the above mixture, 0.05 g [0.1 wt. %] of calcium chloride was added and stirred for 10 min. Then, 0.05 g [0.1 wt. %] of lemongrass oil was added and stirred for 20 min, followed by 0.05 g [0.1 wt. %] of cinnamaldehyde was added and stirred for 30 min. Subsequently, 0.025 ml [0.05 v/wt. %] of commercial fungicide was added and stirred for 10 min, to obtain a mango-banana fruit mixture based polymeric composite base. The mixture was poured onto the desired mould and dried at 40 °C for 48 h. The dried sheet material was washed with 0.09 ml of formic acid and 0.01 ml of sulfuric acid in 99.9 ml water at a pH of 5 for 60 min and then washed with water and dried at 50 °C for 3 h. The dried sheet material was affixed with self-adhesive cotton fabric on one side and surface finished on the other side and embossed with desired grain pattern to obtain a mango-banana fruit mixture based leather-like sheet material. The leather-like material was subjected to characterization. It was found to show the following characteristics,
Fruit fiber content: 83.09 wt %
Tensile strength value: 12±0.7 MPa
Elongation at break value: 11.5±0.5%
Thickness of the material: 0.5±0.12 mm
Area of the sheet: 2500 cm²

### Example 2

500 g of mango fruit, along with 250 g of banana and 250 g of apple fruit (total moisture free weight of fruit mixture was 200 g) were cut into pieces and ground to make them paste mixture. The obtained fruit paste mixture was treated with a combination of 30 g [15 wt. %] of sodium hydroxide and 10 g [5 wt. %] of potassium hydroxide for 30 min. To this mixture, 857.1 ml of biopolyurethane (300 g [150 wt. %] 35% of solid content) was added and stirred for 5 min. Subsequently, 50 g [25 wt. %] of starch dissolved in 50 ml of hot water was added and stirred at 50 °C for 5 min. To this 50 g [25 wt. %] of sodium alginate dissolved in 50 ml of hot water was added and stirred at 50 °C for 10 min. Then, 10 g [5 wt. %] of calcium sulphate was added and stirred for 10 min, followed by 20 g [10 wt. %] of ethylene glycol and stirred for 40 min. Subsequently, 10 g [5 wt. %] of cinnamaldehyde was added and stirred for 30 min. To this mixture, 0.02 ml [0.01 v/wt. %] of commercial fungicide was added and stirred for 30 min, to obtain a fruit mixture based polymeric composite base. The mixture was poured onto a calendaring type machine having roller fitted with a conveyor and dried at 70 °C for 18 h to form a sheet. The dried sheet material was washed with 1 ml of acetic acid and 1 ml of nitric acid dissolved in 198 ml of water at a pH of 3 for 10 min and then washed with water and dried at 70 °C for 1 h. The dried sheet material was affixed with self-adhesive cotton fabric on one side and surface finished on the other side and embossed with desired grain pattern to obtain a fruit mixture based leather-like sheet material. The leather-like material was subjected to characterization. It was found to show the following characteristics,
Fruit fiber content: 29.41 wt %
Tensile strength value: 2.7±0.4 MPa
Elongation at break value: 20±0.5%
Thickness of the material: 1.7±0.22 mm
Area of the sheet: 8415 cm²

### Example 3

100 g of mango fruit, along with 25 g of orange fruit (total moisture free weight of fruit mixture was 25 g) were cut into pieces and ground to make them paste. The obtained blend of fruit paste was treated with 3.75 g [15 wt. %] of sodium hydroxide for 15 min. To this mixture, 147 ml of polyurethane (25 g [100 wt. %] 17% of solid content) was added and stirred for 10 min, followed by 13.9 ml of polyacrylic emulsion (4.17 g [16.68 wt. %] 30% of solid content), 4.16 g [16.64 wt. %] of polycaprolactone and 4.16 g [16.64 wt. %] of poly lactic acid dissolved in 5 ml of acetone was added and stirred at 60 °C for 15 min. To the above mixture, 0.625 g [2.5 wt. %] of silica gel was added and stirred for 10 min. Then, a combination of 0.1 g [0.4 wt. %] of rose oil and 0.025 g [0.1 wt. %] of thyme oil was added and stirred for 10 min, followed by 0.125 g [0.5 wt. %] of glyoxal was added and stirred for 20 min. Subsequently, 0.0625 ml [0.25 v/wt. %] of commercial fungicide was added and stirred for 20 min, to obtain a mango-orange fruit mixture based leather-like sheet material. The mixture was poured onto the desired mould and dried at 50 °C for 38 h. The dried sheet material was affixed with self-adhesive cotton fabric on one side and surface finished on the other side and embossed with desired grain pattern to obtain a fruit mixture based leather-like sheet material. The leather-like material was subjected to characterization. It was found to show the following characteristics,
Fruit fiber content: 37.21 wt %
Tensile strength value: 4.8±0.4 MPa
Elongation at break value: 35±0.5%
Thickness of the material: 0.9±0.23 mm
Area of the sheet: 625 cm²

### Example 4

1,250 g of mango fruit, along with 500 g of banana fruit and 250 g of orange (total moisture free weight of fruit mixture was 400 g) were cut into pieces and ground to make them paste. The obtained blend of fruit paste was treated with 40 g [10 wt. %] of sodium hydroxide for 25 min. To this mixture, 1333.3 ml of polyacrylic emulsion (400 g [100 wt. %] 30% of solid content) was added and stirred at 40 °C for 20 min and then 20 g [5 wt. %] of silica gel dispersed in 40 ml water was added and stirred for 20 min. Then, a combination of 0.4 g [0.1 wt. %] of lavender oil and 0.4 g [0.1 wt. %] of jasmine oil was added and stirred for 20 min, followed by 40 g [10 wt. %] of glutaraldehyde was added and stirred for 30 min. Subsequently, 40 g [10 wt. %] of cinnamaldehyde was added and stirred for 30 min. To the above mixture, 1.2 ml [0.3 v/wt. %] of commercial fungicide was added and stirred for 15 min, to obtain a fruit mixture based polymeric composite base. The mixture was poured onto the desired mould and dried at 60 °C for 28 h. The dried sheet material was surface finished and embossed with desired grain pattern to obtain fruit mixture based leather-like sheet material. The leather-like material was subjected to characterization. It was found to show the following characteristics,
Fruit fiber content: 42.46 wt %
Tensile strength value: 0.5±0.1 MPa
Elongation at break value: 120±3.5%
Thickness of the material: 2±0.18 mm
Area of the sheet: 9100 cm²

### Example 5

1000 g of apple fruit (moisture free weight was 200 g) was cut into pieces and dried at 30 °C for a period 48 h followed by grinding them in powder form. The obtained powder was treated with 800 ml water and 0.2 g [0.1 wt. %] of sodium hydroxide for 10 min. The obtained mixture was mixed with 40 g [20 wt. %] of polyvinyl alcohol (PVA) dissolved in 800 ml hot water and stirred at 90 °C for 10 min, followed by 28.6 ml of biopolyurethane (10 g [5 wt. %] 35% of solid content) was added and stirred at 90 °C for 10 min., followed by 1 g [0.5 wt. %] of calcium chloride and 1 g [0.5 wt. %] of calcium sulphate dissolved in 5 ml water were added to the above solution and stirred for 5 min. To this mixture, 2 g [1 wt. %] of sorbitol and 2 g [1 wt. %] of glycerol were added and stirred for 25 min. Then, 10 g [5 wt. %] of glutaraldehyde was added and stirred for 30 min, followed by 0.8 ml [0.4 v/wt. %] of commercial fungicide was added and stirred for 15 min, to obtain an apple based polymeric substrate. The mixture was poured onto the desired mould and dried at 55 °C for 33 h. The dried sheet material was affixed with self-adhesive cotton fabric on one side and surface finished on the other side and embossed with desired grain pattern to obtain a fruit mixture based leather-like sheet material. The leather-like material was subjected to characterization. It was found to show the following characteristics,
Fruit fiber content: 74.90 wt %
Tensile strength value: 8.3±0.4 MPa
Elongation at break value: 45±0.5%
Thickness of the material: 0.85±0.12 mm
Area of the sheet: 7300 cm²

### Example 6

150 g of mango fruit (moisture free weight was 30 g) was cut into pieces and ground to make paste. The obtained mango paste was treated with 0.03 g [0.1 wt. %] of sodium hydroxide for 25 min. The obtained mixture was added with polyvinyl alcohol (PVA) solution (3 g [10 wt. %] PVA in 200 ml water) and stirred at 90 °C for 10 min. To the above mixture, 0.3 g [0.1 wt. %] of silica gel was added and stirred for 10 min. In this mixture, 0.3 g [1 wt. %] of glycerol was added and stirred for 20 min, followed by 3 g [10 wt. %] of lemongrass oil was added and stirred for 20 min. Then, 1 g [3.33 wt. %] of glutaraldehyde was added and stirred for 30 min. Subsequently, 0.015 ml [0.05 v/wt. %] of commercial fungicide was added and stirred for 30 min, to obtain a mango based polymeric substrate. The mixture is poured onto the desired mould and dried at 45 °C for 40 h. The dried sheet material was affixed with self-adhesive cotton-jute fabric on one side and surface finished on the other side and embossed with desired grain pattern to obtain mango based leather-like sheet material. The leather-like material was subjected to characterization. It was found to show the following characteristics,
Fruit fiber content: 79.69 wt %
Tensile strength value: 12±0.6 MPa
Elongation at break value: 10±0.9%
Thickness of the material: 0.62±0.12 mm
Area of the sheet: 1300 cm²

### Example 7

150 g of banana fruit (moisture free weight was 30 g) was cut into pieces and ground to make paste. The obtained banana paste was treated with 0.6 g [2 wt. %] of sodium hydroxide for 15 min and mixed with polyvinyl alcohol (PVA) solution (5 g [16.67 wt. %] PVA in 300 ml water) and stirred at 90 °C for 10 min. To the above mixture, 0.03 g [0.1 wt. %] of silica gel was added and stirred for 10 min. To this mixture, 0.5 g [1.67 wt. %] of glycerol was added and stirred for 20 min. Then, 1 g [3.33 wt. %] of cinnamaldehyde was added and stirred for 30 min followed by 0.03 ml [0.1 v/wt. %] commercial fungicide was added and stirred for 10 min, to obtain a banana based polymeric substrate. The mixture is poured onto the desired mould and dried at 60 °C for 36 h. The dried sheet material was washed with 0.1 ml sulfuric acid dissolved in 99.9 ml of water at a pH of 4 for 30 min and then washed with water and dried at 40 °C for 4 h. The dried sheet material was surface finished and embossed with desired grain pattern to obtain fruit based leather-like sheet material. The leather-like material was subjected to characterization. It was found to show the following characteristics,
Fruit fiber content: 80.73 wt %
Tensile strength value: 2.94±0.9 MPa
Elongation at break value: 21.3±1.3%
Thickness of the material: 0.76±0.04 mm
Area of the sheet: 1200 cm²

### Example 8

300 g of apple fruit (moisture free weight was 60 g) was cut into pieces and dried at 45 °C for a period 40 h followed by grinding them in powder form. The obtained 60 g powder was treated with 240 ml water and 0.06 g [0.1 wt. %] of sodium hydroxide for 10 min. The obtained mixture was mixed with polyvinyl alcohol (PVA) solution (15 g [25 wt. %] PVA in 300 ml water) and stirred at 90 °C for 10 min. To the above mixture, 0.15 g [0.25 wt. %] of silica gel was added and stirred for 10 min. To this mixture, 1 g [1.67 wt. %] of glycerol was added and stirred for 20 min. Then, 1 g [1.67 wt. %] of glutaraldehyde was added and stirred for 30 min followed by 0.30 ml [0.5 v/wt. %] commercial fungicide was added and stirred for 10 min, to obtain an apple based polymeric substrate. The mixture is poured onto the desired mould and dried at 60 °C for 36 h. The dried sheet material was washed with 0.1 ml nitric acid dissolved in 99.9 ml of water at a pH of 4 for 45 min and then washed with water and dried at 50 °C for 3 h. The dried sheet material was surface finished and embossed with desired grain pattern to obtain fruit based leather-like sheet material. The leather-like material was subjected to characterization. It was found to show the following characteristics,
Fruit fiber content: 77.41 wt %
Tensile strength value: 4.4±0.2 MPa
Elongation at break value: 25.8±0.8%
Thickness of the material: 0.7±0.01 mm
Area of the sheet: 2400 cm².

A comparative table illustrating the synergistic effect of the ingredients used in making the desired fruit-based leather like material is shown below table 2:

TABLE 2

| | Composition | | | | | Other | |
|---|---|---|---|---|---|---|---|
| | (Fruit + | | | | | ingredients | |
| | Alkali + | | | | | (Crosslinker/ | |
| | Polymer + | | | | | platicizer/ | |
| | Additive + | | | | | fragrant | |
| Sl. | Other | Fruit | Polymer | Alkali | Additive | oil/fungicide) | |
| No. | ingredients) | (%) | (%) | (%) | (%) | (%) | Results/observations |
| 1 | Fruit + | 83.09 | 8.31 | 8.31 | 0.08 | 0.21 | Brown colored sheet |
| | Polymer + | | | | | | formed with fairly- |
| | Additive + | | | | | | good strength after |
| | Crosslinker + | | | | | | attaching the textile |
| | Other | | | | | | backup |
| | ingredients | | | | | | |
| 2 | Fruit + | 29.41 | 58.82 | 5.88 | 1.47 | 4.41 | Brown colored sheet |
| | Polymer + | | | | | | formed with low |
| | Additive + | | | | | | strength even after |
| | Crosslinker + | | | | | | attaching the textile |
| | Other | | | | | | backup, owing to high |
| | ingredients | | | | | | thickness |
| 3 | Fruit + | 37.21 | 55.81 | 5.58 | 0.93 | 0.47 | Brown colored sheet |
| | Polymer + | | | | | | formed with average |
| | Additive + | | | | | | strength after |
| | Crosslinker + | | | | | | attaching the textile |
| | Other | | | | | | backup |
| | ingredients | | | | | | |
| 4 | Fruit + | 42.46 | 42.46 | 4.25 | 2.12 | 8.7 | Brown colored sheet |
| | Polymer + | | | | | | formed with very low |
| | Additive + | | | | | | strength, owing to |
| | Crosslinker + | | | | | | high thickness as well |
| | Other | | | | | | as the absence of |
| | ingredients | | | | | | textile backup |
| 5 | Fruit + | 74.90 | 18.73 | 0.07 | 0.75 | 5.54 | Brown colored sheet |
| | Polymer + | | | | | | formed with good |
| | Additive + | | | | | | strength after |
| | Crosslinker + | | | | | | attaching the textile |
| | Other | | | | | | backup |
| | ingredients | | | | | | |
| 6 | Fruit + | 79.69 | 7.97 | 0.08 | 0.79 | 11.46 | Brown colored sheet |
| | Polymer + | | | | | | formed with fairly- |
| | Additive + | | | | | | good strength after |
| | Crosslinker + | | | | | | attaching the cotton- |
| | Other | | | | | | jute textile backup |
| | ingredients | | | | | | |
| 7 | Fruit + | 80.73 | 13.46 | 1.61 | 0.08 | 4.12 | Brown colored sheet |
| | Polymer + | | | | | | formed with low |
| | Additive + | | | | | | strength, owing to less |
| | Crosslinker + | | | | | | polymer content as |
| | Other | | | | | | well as the absence of |
| | ingredients | | | | | | textile backup |
| 8 | Fruit + | 77.41 | 19.35 | 0.08 | 0.19 | 2.97 | Brown colored sheet |
| | Polymer + | | | | | | formed with average |
| | Additive + | | | | | | strength, owing to less |
| | Crosslinker + | | | | | | polymer content as |
| | Other | | | | | | well as the absence of |
| | ingredients | | | | | | textile backup |
| 9 | Fruit | 100 | 0 | 0 | 0 | 0 | No sheet formation |
| 10 | Polymer | 0 | 100 | 0 | 0 | 0 | Only polymeric sheet |
| | | | | | | | formed without any |
| | | | | | | | fruit component |
| 11 | Fruit + | 50 | 50 | 0 | 0 | 0 | Sheet formed with |
| | Polymer | | | | | | extremely low |
| | | | | | | | strength with bad odor |
| | | | | | | | indicating |
| | | | | | | | putrefaction |
| 12 | Fruit + | 50 | 0 | 0 | 0 | 50 | No sheet formation |
| | Other | | | | | | |
| | reactants | | | | | | |
| 13 | Fruit + | 50 | 0 | 0 | 50 | 0 | No sheet formation |
| | Additive | | | | | | |
| 14 | Fruit + | 50 | 0 | 50 | 0 | 0 | No sheet formation |
| | Crosslinker | | | | | | |

From the above table, it is demonstrated that: Fruit based leather-like material, comprising:
[a] 30 to 83 wt % of fruit paste/powder;
[b] 8 to 59 wt % of polymer(s);
[c] 0.07 to 8.3 wt % of alkali(s);
[d] 0.08 to 2.1 wt % of additive(s); optionally along with
[e] 0.2 to 11.5 wt % of other ingredients such as plasticizer, fragrant oil, cross-linker and fungicide;
is the range of ingredients in which the present invention works; any value taken above and below this range will lead to undesirable results.

### Advantages of the Invention

The following are the advantages of the present invention:
The product of invention used for manufacturing of fancy lifestyle articles and many other products.
It offers a simple process for the preparation of fruit based leather-like material with different size/thickness ranges
The process of invention is easy, convenient and ecofriendly.
The process converts fruit waste materials into valuable products, and hence reduces pollution load in the environment
The process avoids toxic and expensive chemicals.
The implementation of the process is possible with minimum investment.

We claim:

1. A fruit based leather-like material, comprising:
[a] 30 to 83 wt % of fruit paste/powder;
[b] 8 to 59 wt % of polymer(s);
[c] 0.07 to 8.3 wt % of alkali(s);
[d] 0.08 to 2.1 wt % of additive(s); optionally along with
[e] 0.2 to 11.5 wt % of other ingredients selected from plasticizer, fragrant oil, cross-linker and fungicide;
wherein the material is characterized by fruit fiber based polymeric composite matrix in the form of a sheet having not less than 30 to 83 wt % of fruit fiber, the sheet having thickness in the range of 0.5 mm to 2.0 mm, tensile strength in the range of 0.5 to 12 MPa and elongation at break in the range of 10 to 120%,
wherein wt % of the components [a]-[e] in the leather-like material is 100%.

2. A process for preparing the fruit based leather-like material as claimed in claim 1, wherein the steps comprising:
(i) converting a fruit material into a paste, optionally followed by drying at 30 to 60 degree c as well as powdering to obtain fruit paste/powder;
(ii) treating the fruit paste/powder as obtained in step (i) with 0.1 to 20% w/w of alkali under stirring condition, and 10 to 200% w/w of polymer, based on the moisture-free weight of the fruit material, at a temperature ranging from 30 to 90 degree c for a time period of 10 to 30 min, followed by adding 0.1 to 5.0% w/w of an additive under constant stirring to obtain a mixture;
(iii) treating the mixture as obtained in step (ii) optionally with 1 to 10% w/w of a plasticizer and 0.1 to 10% w/w of a fragrant oil for 20 to 40 min;
(iv) treating the mixture, as obtained in step (ii) or (iii) optionally with 0.1 to 20% w/w of a cross-linker for 30 to 60 min followed by 0.01 to 0.5% v/w of fungicide for 10 to 30 min, to obtain a fruit based polymeric substrate;
(v) subjecting the substrate, as obtained in step (iv) to casting, followed by drying at 40 to 70 degree c for 18 to 48 h and subsequent acid washing at a pH in the range of 3 to 5 followed by aqueous washing and drying at 40 to 70 degree c for 1 to 4 h, to obtain fruit based dry composite sheet;
(vi) affixing a natural fiber substrate on one surface of the dry composite sheet, as obtained in step (v), as an optional step, followed by surface finishing on the other side by a known method to obtain the fruit based leather-like material.

3. The process as claimed in claim 2, wherein the fruit material used is selected from mango, banana, apple, orange, either individually or in any combination.

4. The process as claimed in claim 2, wherein the alkali is selected from sodium hydroxide, potassium hydroxide, either individually or in any combination.

5. The process as claimed in claim 2, wherein the polymer is selected from poly vinyl alcohol, polyurethane, biopolyurethane, polyacrylic emulsion, starch, sodium alginate, polycaprolactone and poly lactic acid, either individually or in any combination.

6. The process as claimed in claim 2, wherein the additive is selected from calcium chloride, calcium sulphate and silica gel, either individually or in any combination.

7. The process as claimed in claim 2, wherein the plasticizer is selected from glycerol, ethylene glycol, sorbitol, either individually or in any combination.

8. The process as claimed in claim 2, wherein the fragrant oil is selected from lemongrass oil, lavender oil, thyme oil, jasmine oil, rose oil, either individually or in any combination.

9. The process as claimed in claim 2, wherein the cross-linker is selected from glutaraldehyde, cinnamaldehyde, glyoxal, either individually or in any combination.

10. The process as claimed in claim 2, wherein the natural fiber substrate is selected from cotton fabric, cotton-jute fabric or in any combination.
